(19) United States
(12) Patent Application Publication
(10) Pub. No.: US 2012/0185714 A1
(43) Pub. Date: Jul. 19, 2012

(54) METHOD, APPARATUS, AND SYSTEM FOR ENERGY EFFICIENCY AND ENERGY CONSERVATION INCLUDING CODE RECIRCULATION TECHNIQUES

(76) Inventors: Jaewoong Chung, Sunnyvale, CA (US); Youfeng Wu, Palo Alto, CA (US); Cheng Wang, San Ramon, CA (US); Hanjun Kim, Santa Clara, CA (US)

(21) Appl. No.: 13/327,683

(22) Filed: Dec. 15, 2011

(51) Int. Cl. G06F 1/32; G06F 9/38; G06F 9/312; G06F 15/76; G06F 9/30

(52) U.S. Cl. 713/323; 712/42; 712/208; 712/E09.033; 712/E09.028; 712/E09.045; 712/E09.023

(57) ABSTRACT

An apparatus, method and system is described herein for enabling intelligent recirculation of hot code sections. A hot code section is determined and marked with a begin and end instruction. When the begin instruction is decoded, recirculation logic in a back-end of a processor enters a detection mode and loads decoded loop instructions. When the end instruction is decoded, the recirculation logic enters a recirculation mode. And during the recirculation mode, the loop instructions are dispatched directly from the recirculation logic to execution stages for execution. Since the loop is being directly serviced out of the back-end, the front-end may be powered down into a standby state to save power and increase energy efficiency. Upon finishing the loop, the front-end is powered back on and continues normal operation, which potentially includes propagating next instructions after the loop that were prefetched before the front-end entered the standby mode.

### FIELD

This disclosure pertains to energy efficiency and energy conservation in integrated circuits, as well as code to execute thereon, and in particular but not exclusively, to code recirculation.

### BACKGROUND

Advances in semi-conductor processing and logic design have permitted an increase in the amount of logic that may be present on integrated circuit devices. As a result, computer system configurations have evolved from a single or multiple integrated circuits in a system to multiple hardware threads, multiple cores, multiple devices, and/or complete systems on individual integrated circuits. Additionally, as the density of integrated circuits has grown, the power requirements for computing systems (from embedded systems to servers) have also escalated. Furthermore, software inefficiencies, and its requirements of hardware, have also caused an increase in computing device energy consumption. In fact, some studies indicate that computers consume a substantial amount of the entire electricity supply for the United States of America.

As a result, there is a vital need for energy efficiency and conservation associated with integrated circuits. And as servers, desktop computers, notebooks, ultrabooks, tablets, mobile phones, processors, embedded systems, etc. become even more prevalent (from inclusion in the typical computer, automobiles, and televisions to biotechnology), the effect of computing device sales stretches well outside the realm of energy consumption into a substantial, direct effect on economic systems.

When power consumption becomes more of a factor, the trend towards always increasing performance is now being counterbalanced with power consumption concerns. As a result, portions of integrated circuits have been opportunistically powered down, such as placing a processor in a sleep state. Yet, current processors still often keep portions of their pipeline active; even when they may be idle, which potentially wastes power to keep logic active with no work to perform. Furthermore, other power savings opportunities, such as enabling a portion of a processing pipeline to become idle (e.g. offloading work from one portion of a pipeline to free it for power savings) are also often missed. For example, during execution of code, some hot portions (e.g. often executed code sections) potentially waste power through the whole front-end pipeline, as well as potentially cause adverse performance issues (e.g. when an instruction is mis-aligned over two cache lines and is to be fetched over two cycles).

### BRIEF DESCRIPTION OF THE DRAWINGS

The present invention is illustrated by way of example and not intended to be limited by the figures of the accompanying drawings.

FIG. 1 illustrates an embodiment of a logical representation of a system including processor having multiple processing elements (2 cores and 4 thread slots).

FIG. 2 illustrates an embodiment of a logical representation of a computer system configuration.

FIG. 3 illustrates another embodiment of a logical representation of a computer system configuration.

FIG. 4 illustrates another embodiment of a logical representation of a computer system configuration.

FIG. 5 illustrates an embodiment of a logical representation of a device to provide intelligent code recirculation for hot portions of code.

FIG. 6 illustrates another embodiment of a logical representation of a device to provide intelligent code recirculation for hot portions of code.

FIG. 7 illustrates an embodiment of a logical representation of recirculation logic capable of recalculating nested loops within code.

FIG. 8 illustrates an embodiment of a flow diagram for recirculating hot code, while saving power in a front-end of a processor pipeline.

### DETAILED DESCRIPTION

In the following description, numerous specific details are set forth, such as examples of specific types of specific processor and system configurations, specific hardware structures, specific architectural and micro architectural details, specific register configurations, specific methods of marking instructions, specific types of hot code, specific recirculation structures, specific loop instructions, specific front-end logic, specific processor pipeline stages and operation, specific end loop iteration conditions, etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific branch prediction logic and methods, specific hot code identification methods, specific dynamic compilation techniques, specific power down and gating techniques/logic and other specific operational details of processors haven't been described in detail in order to avoid unnecessarily obscuring the present invention.

Although the following embodiments are described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems. And may be also used in other devices, such as handheld devices, systems on a chip (SOC), and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations .

The method and apparatus described herein are for providing intelligent code recirculation. Specifically, code recirculation is primarily discussed below in reference to a microprocessor; and power savings therein. Yet, the apparatus' and methods described herein are not so limited, as they may be implemented in conjunction with any integrated circuit device. For example, the code recirculation techniques described herein may be utilized in a graphics processor that executes iterative and/or hot code. Or it may be utilized in small form-factor devices, handheld devices, SOCs, or embedded applications, as discussed above.

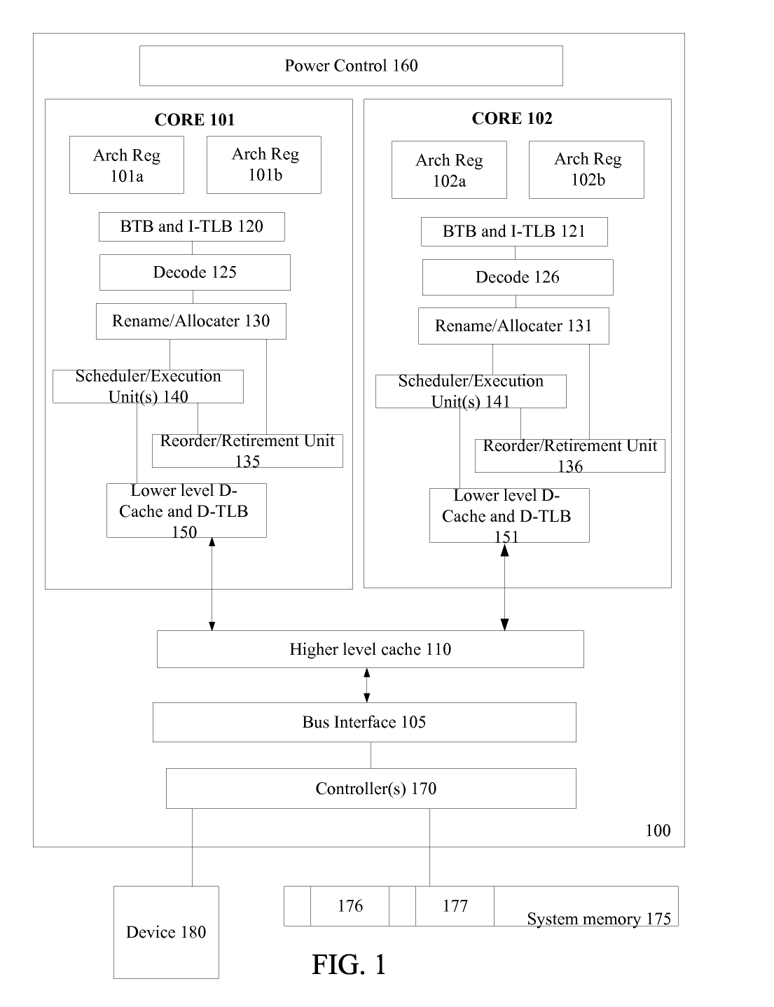

Referring to FIG. 1, an embodiment of a processor including multiple cores is illustrated. Processor 100 includes any processor or processing device, such as a microprocessor, an embedded processor, a digital signal processor (DSP), a network processor, a handheld processor, an application processor, a co-processor, a system on a chip (SOC), or other device to execute code. Processor 100, in one embodiment, includes at least two cores—core 101 and 102, which may include asymmetric cores or symmetric cores (the illustrated embodiment). However, processor 100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores, core 101 and 102. Here, core 101 and 102 are considered symmetric cores, i.e. cores with the same configurations, functional units, and/or logic. In another embodiment, core 101 includes an out-of-order processor core, while core 102 includes an in-order processor core. However, cores 101 and 102 may be individually selected from any type of core, such as a native core, a software managed core, a core adapted to execute a native Instruction Set Architecture (ISA), a core adapted to execute a translated Instruction Set Architecture (ISA), a co-designed core, or other known core. Yet to further the discussion, the functional units illustrated in core 101 are described in further detail below, as the units in core 102 operate in a similar manner.

As depicted, core 101 includes two hardware threads 101a and 101b, which may also be referred to as hardware thread slots 101a and 101b. Therefore, software entities, such as an operating system, in one embodiment potentially view processor 100 as four separate processors, i.e. four logical processors or processing elements capable of executing four software threads concurrently. As eluded to above, a first thread is associated with architecture state registers 101a, a second thread is associated with architecture state registers 101b, a third thread may be associated with architecture state registers 102a, and a fourth thread may be associated with architecture state registers 102b. Here, each of the architecture state registers (101a, 101b, 102a, and 102b) may be referred to as processing elements, thread slots, or thread units, as described above. As illustrated, architecture state registers 101a are replicated in architecture state registers 101b, so individual architecture states/contexts are capable of being stored for logical processor 101a and logical processor 101b. In core 101, other smaller resources, such as instruction pointers and renaming logic in allocator and renamer block 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register(s), low-level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, core 101 includes a simplified, representative out-of-order (OOO) processor core. But an in-order processor may be utilized in different embodiments. The OOO core includes a branch target buffer 120 to predict branches to be executed/taken and an instruction-translation buffer (I-TLB) 120 to store address translation entries for instructions.

Core 101 further includes decode module 125 coupled to fetch unit 120 to decode fetched elements. Fetch logic, in one embodiment, includes individual sequencers associated with thread slots 101a, 101b, respectively. Usually core 101 is associated with a first Instruction Set Architecture (ISA), which defines/specifies instructions executable on processor 100. Often machine code instructions that are part of the first ISA include a portion of the instruction (referred to as an opcode), which references/specifies an instruction or operation to be performed. Decode logic 125 includes circuitry that recognizes these instructions from their opcodes and passes the decoded instructions on in the pipeline for processing as defined by the first ISA. For example, as discussed in more detail below decoders 125, in one embodiment, include logic designed or adapted to recognize specific instructions, such as transactional instruction. As a result of the recognition by decoders 125, the architecture or core 101 takes specific, predefined actions to perform tasks associated with the appropriate instruction. It is important to note that any of the tasks, blocks, operations, and methods described herein may be performed in response to a single or multiple instructions; some of which may be new or old instructions.

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 101 and 102 share access to higher-level or further-out cache 110, which is to cache recently fetched elements. Note that higher-level or further-out refers to cache levels increasing or getting further way from the execution unit(s). In one embodiment, higher-level cache 110 is a last-level data cache—last cache in the memory hierarchy on processor 100—such as a second or third level data cache. However, higher level cache 110 is not so limited, as it may be associated with or include an instruction cache. A trace cache—a type of instruction cache—instead may be coupled after decoder 125 to store recently decoded traces.

In the depicted configuration, processor 100 also includes bus interface module 105. Historically, controller 170, which is described in more detail below, has been included in a computing system external to processor 100. In this scenario, bus interface 105 is to communicate with devices external to processor 100, such as system memory 175, a chipset (often including a memory controller hub to connect to memory 175 and an I/O controller hub to connect peripheral devices), a memory controller hub, a northbridge, or other integrated circuit. And in this scenario, bus 105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 175 may be dedicated to processor 100 or shared with other devices in a system. Common examples of types of memory 175 include dynamic random access memory (DRAM), static RAM (SRAM), non-volatile memory (NV memory), and other known storage devices. Note that device 180 may include a graphic accelerator, processor or card coupled to a memory controller hub, data storage coupled to an I/O controller hub, a wireless transceiver, a flash device, an audio controller, a network controller, or other known device.

Note however, that in the depicted embodiment, the controller 170 is illustrated as part of processor 100. Recently, as more logic and devices are being integrated on a single die, such as System on a Chip (SOC), each of these devices may be incorporated on processor 100. For example in one embodiment, memory controller hub 170 is on the same package and/or die with processor 100. Here, a portion of the core (an on-core portion) includes one or more controller(s) 170 for interfacing with other devices such as memory 175 or a graphics device 180. The configuration including an interconnect and controllers for interfacing with such devices is often referred to as an on-core (or un-core configuration). As an example, bus interface 105 includes a ring interconnect with a memory controller for interfacing with memory 175 and a graphics controller for interfacing with graphics processor 180. Yet, in the SOC environment, even more devices, such as the network interface, co-processors, memory 175, graphics processor 180, and any other known computer devices/interface may be integrated on a single die or integrated circuit to provide small form factor with high functionality and low power consumption.

In one embodiment, processor 100 is capable of executing a compiler, optimization, and/or translator code 177 to compile, translate, and/or optimize application code 176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

In one embodiment, processor 100 is configured to recirculate hot portions of code. Here, hot portions of code are identified by hardware, firmware, software, or a combination thereof. For example, a dynamic compiler profiles/tracks execution during runtime. And code sections, such as loops, are identified as hot (e.g. if a loop iterates more than a predetermined number of times it is identified as hot) and marked by the dynamic compiler. In this scenario, any known method of marking code may be utilized (e.g. setting a bit or encoding a bit in one or more instructions that define the section of code). For example, a bit is set in a begin instruction (e.g. an atomic start or other loop start instruction) and/or a bit is set in an end instruction (e.g. a branch or other end loop instruction) for a loop.

In one embodiment, when the hot loop is detected (e.g. marked sections are decoded), recirculation hardware is utilized to recirculate the hot code (e.g. a loop) for execution by execution units 140. For example, assume a hot loop is identified by a dynamic compiler (or other code). After the beginning of the hot loop is detected (e.g. decoded by decode logic 125), the rest of the hot loop is decoded by decode logic 125 and propagated through the pipeline of processor 100 filling recirculation hardware, so as to hold a decoded format of the hot loop. Note that the hot loop may be normally dispatched from instruction buffers or directly dispatched from the recirculation hardware for execution by execution units 140 upon a first iteration of the loop. Here, recirculation hardware may be placed anywhere in the pipeline after decoders 125. However, in one embodiment, to accelerate the dispatch to execution time, the recirculation hardware is placed as close to execution units 140 as possible (e.g. immediately preceding execution units 140).

The recirculation hardware continues to fill with loop instructions until its full or until the end loop instruction is detected/decoded. When filled, the loop body is able to be dispatched directly from recirculation hardware to execution units 140 upon subsequent iterations of the loop. As can be inferred from this example, since a loop recursively executes and is able to be dispatched from recirculation hardware, the front-end (e.g. fetch logic and branch prediction logic 120), which usually predicts branches to be taken and fetches new code, are potentially not in-use. Or at least the processor pipeline doesn't substantially benefit from further operation of the front-end. As a result, in one embodiment, during a loop recirculation mode (i.e. when the loop is being served out of the recirculation hardware), the front-end is powered-down. Here, powered-down may include a voltage level of zero. However, in an alternative embodiment, powered-down includes a standby mode, where data in the fetch/branch prediction logic 120 is not lost. As discussed below in more detail, as a potential advantage, the powering down of branch prediction logic, maintaining of branch prediction information beyond the loop, and power back-up potentially results in accelerated execution after the loop.

Therefore, as can be seen, instead of fetching instructions from memory 175 or an instruction cache located before decode logic 125 and waiting for the instructions to propagate through the entire pipeline of processor 100 each time instructions are encountered during another iteration of the loop, the loop instructions are able to be dispatched directly from a recirculation queue in decoded format. And the location of the recirculation queue—close (in physical and stage) proximity to execution units 140—enables more efficient and faster loop execution. Consequently, performance for identified hot loops is potentially dramatically increased. Moreover, movement of the loop to recirculation hardware after decode logic 125 allows a front-end to be powered down during recirculation to save power. As a result, performance is increased, while at the same time energy efficient power savings is achieved.

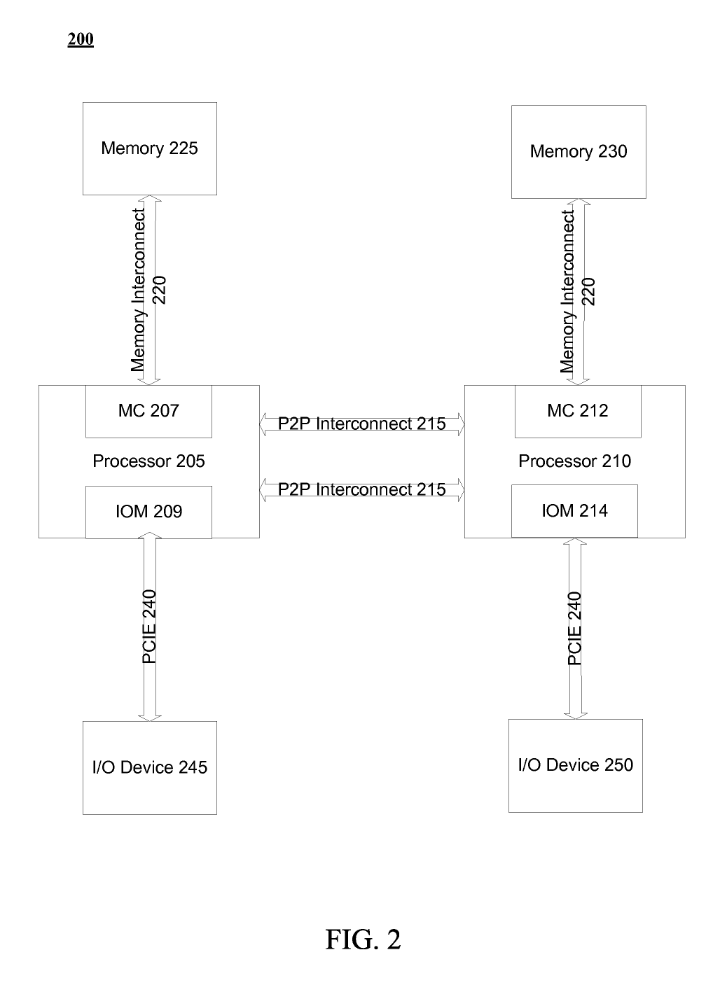

Referring to FIGS. 2-4, embodiments of a computer system configurations adapted to include processors with configurable maximum current is illustrated. In reference to FIG. 2, an illustrative example of a two processor system 200 with an integrated memory controller and Input/Output (I/O) controller in each processor 205, 210 is illustrated. Although not discussed in detail to avoid obscuring the discussion, platform 200 illustrates multiple interconnects to transfer information between components. For example, point-to-point (P2P) interconnect 215, in one embodiment, includes a serial P2P, bi-directional, cache-coherent bus with a layered protocol architecture that enables high-speed data transfer. Moreover, a commonly known interface (Peripheral Component Interconnect Express, PCIE) or variant thereof is utilized for interface 240 between I/O devices 245, 250. However, any known interconnect or interface may be utilized to communicate to or within domains of a computing system.

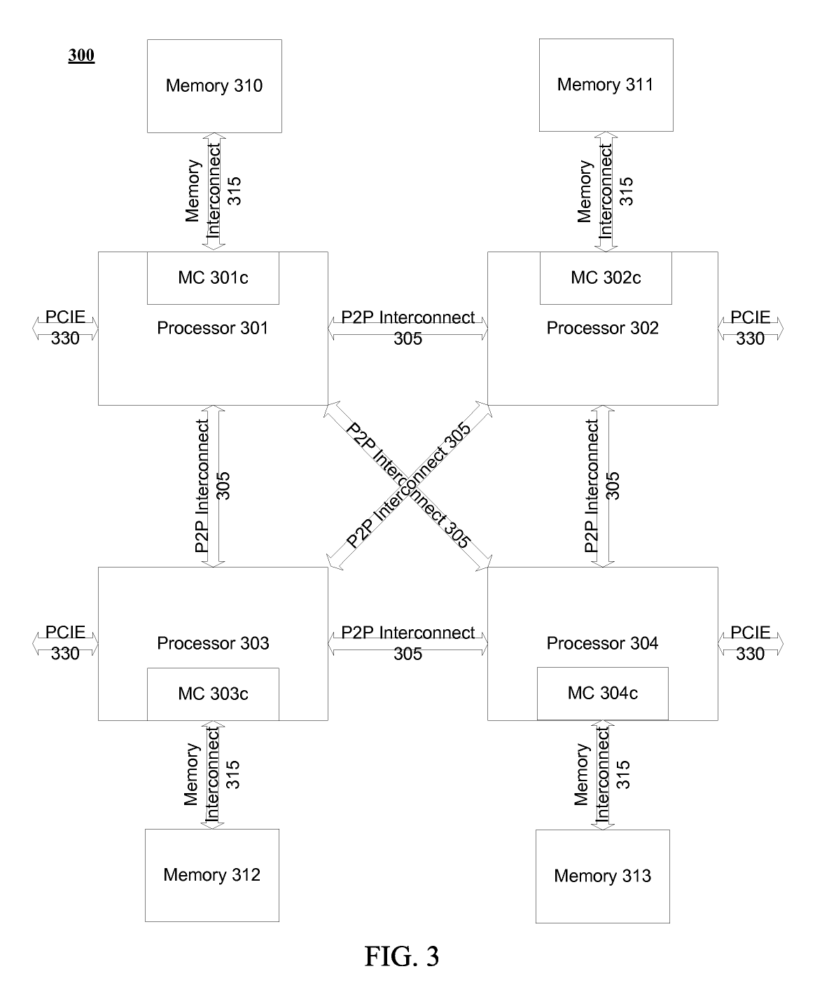

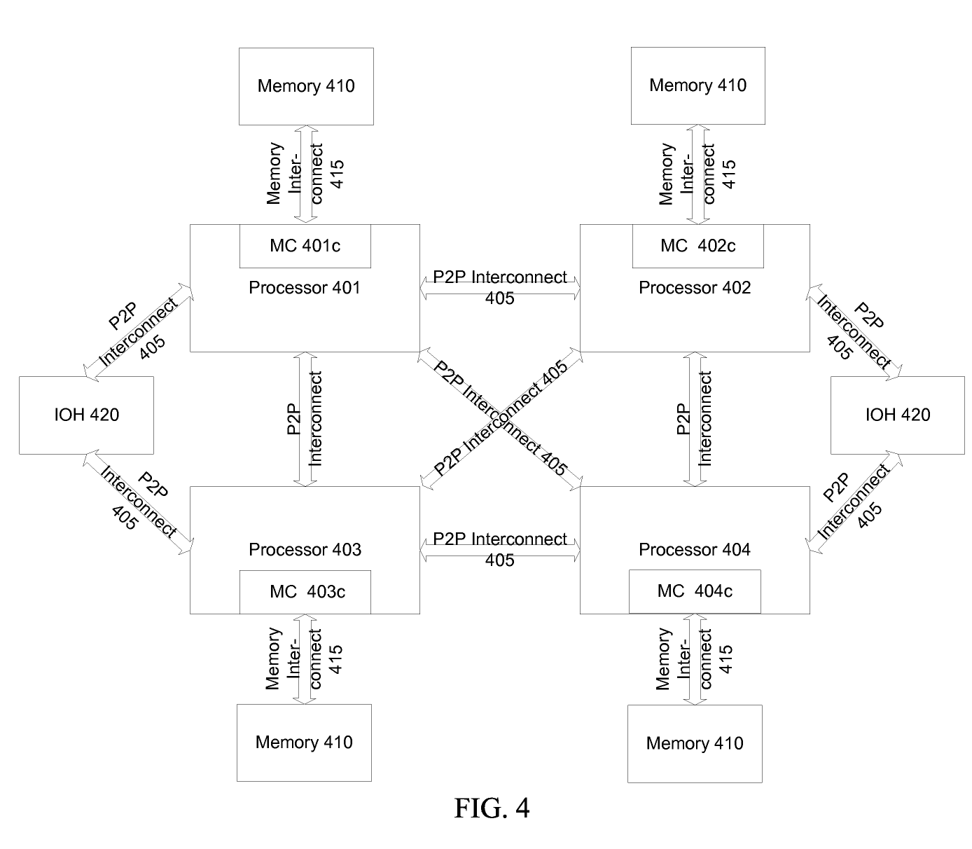

Turning to FIG. 3 a quad processor platform 300 is illustrated. As in FIG. 2, processors 301-304 are coupled to each other through a high-speed P2P interconnect 305. And processors 301-304 include integrated controllers 301c-304c. FIG. 4 depicts another quad core processor platform 400 with a different configuration. Here, instead of utilizing an on-processor I/O controller to communicate with I/O devices over an I/O interface, such as a PCI-E interface, the P2P interconnect is utilized to couple the processors and I/O controller hubs 420. Hubs 420 then in turn communicate with I/O devices over a PCIE-like interface.

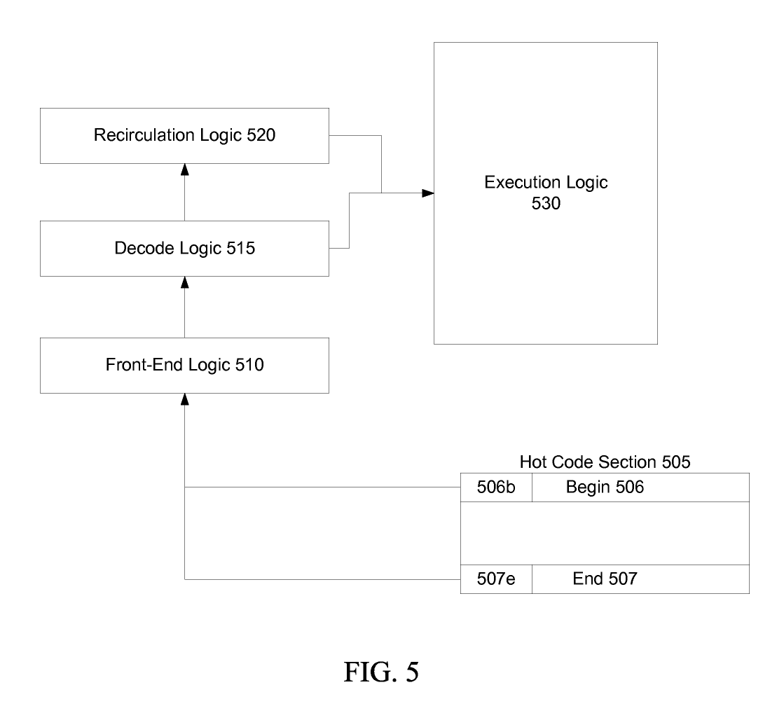

Referring next to FIG. 5, an embodiment of a logical representation of modules to enable recirculation of hot sections of code is illustrated. Hot code section 505 includes any known ‘hot’ or recurrent portion of code. As a first example, code section 505 includes an iterative section of code, such as a loop (e.g. commonly known in programming language as a for or while loop). Here, any loop that is to recursively execute may—based on the design implementation—be determined to be a ‘hot loop’ or hot section of code. In another embodiment, if loop 505 executes more than a threshold number of times, then it's determined to be a hot section of code. In this scenario, hardware, firmware, software, or a combination thereof tracks code executed, such as tracking execution with a dynamic compiler during runtime. Specifically, it's determined how many times loop 505 is executed (i.e. how many times a piece of code is looped through). And if the number of times is greater than or equal to the threshold, then hot code section 505 is marked as such.

Note that hot code section 505 is not limited to a loop, but rather in another embodiment refers to any portion of code frequently executed or re-executed. For example, a program may frequently call a specific function from library code. As a result of the frequency of the call over an amount of time, it's determined that the function is ‘hot code.’ Therefore, the function is marked as a hot section. And when the function call instruction (e.g. a branch instruction) is encountered, the recirculation techniques described herein are utilized (e.g. the decoded format of instructions for the function are dispatched from a recirculation queue in recirculation logic 520 by execution logic 530). As can be taken from this illustrative example, hot code is not limited to consecutive, recursive execution. But rather hot code, in at least one scenario, includes code frequently executed (e.g. a number of times executed or encountered over a quantum of time), even when other code is executed in between. Other examples of groupings of code that may be often executed (and as a result be determined to be hot code) include a transaction, an atomic group of instructions/operations, a helper thread, etc.

Yet, regardless of the ‘type’ of hot code section 505, once identified, the code section 505 is marked, as discussed above. Any known method of identifying a specific portion of code or delimiting a portion of code may be used here. As a first example, new instructions are placed as beginning instruction 506 and end instruction 507 to mark code section 505 is hot code. In another embodiment, storage structures, such as registers (not shown), are loaded with address ranges that identify one or more sections of hot code. In yet another scenario, beginning instruction 506 and end instruction 507 is compiled, recompiled, optimized, translated, augmented, modified, encoded, or altered to indicate code section 505 is a hot section of code. For example, assume section 505 is a loop. A begin loop instruction 506 includes a field 506b (which may also referred to as a bit or bit position but is not limited to a single bit or bit position) in begin instruction 506 to mark/indicate a beginning of a hot section of code. In other words, when begin instruction 506 includes bit position 506b set to a begin hot section value, it indicates that the following code (code section 505) is a hot section of code. Similarly, in conjunction with end instruction 507, which includes 507e set to an end hot section value, begin instruction 506—as described above—defines hot section 505.

As mentioned above in regards to FIG. 1, an encoding of an instruction and the bit positions therein may be defined by an Instruction Set Architecture (ISA). In other words, decode logic 515 is designed and configured to recognize certain patterns in code/instructions. So when begin instruction 506 is received with a specific operation code (opcode), decode logic 515 is designed and configured to look at bit position 506b. If 506b is set to a begin hot section value, then decode logic 515 recognizes that a hot code section 505 is being defined. And the rest of the pipeline stages (e.g. recirculation logic 520, as well as other stages) take predefined actions based on decode logic 515's interpretation of field 506b. Note that field 506b may be part of the instruction itself, a prefix, hint, an appended bit, or other field or storage location that associates information with an instruction. As may be implied by the numerous forms of marking an instruction, such marking may be explicit (i.e. definitively marking section 505 as hot) or may be a hint (i.e. a software indication that section 505 is hot, which hardware or firmware may choose to accept or ignore based on any other factor).

Therefore, once hot section 505 is identified and marked, either by hardware, firmware, software, or a combination thereof, decode logic 515 decodes code that is fetched by front-end logic 510 (e.g. code section 505 is fetched into an instruction cache (not shown)). In response to decode logic decoding begin instruction 506 with bit position 506b marked, recirculation logic 520 enters a detection mode. Here, the beginning of code section 505 has been encountered, but the entirety of the code section may not yet have been discovered. Therefore, in detection mode instructions of code section 505 are decoded by decode logic 515 and stored in recirculation logic 520 in a decoded format. Note that storage of the decoded format of hot code section 505 in recirculation logic 520 doesn't preclude normal pipeline operation as well (e.g. storage of the decoded instructions in normal buffers and the normal dispatch process). In this scenario, in the loop detection mode, recirculation logic 520 is loading the decoded format of code section 505. And in at least partially parallel, execution logic 530 is executing the decoded format of code section 505. As a result, the instructions are dispatched from either recirculation logic 520 as it loads or normal buffers, depending on the chosen implementation.

In one embodiment, recirculation logic 520 includes a storage structure coupled after decode logic 515 to hold the decoded format of hot code section 505. The storage structure may include any known non-transitory readable medium or structure. Examples of such a storage facility include a queue, a buffer, registers, memory, cache, etc. From the difference alone between FIGS. 1 and 5, it can be seen that numerous processor pipeline stages have been omitted from the illustration in FIG. 5. However, recirculation logic 520 is depicted as coupled after decode logic 515, but any number of stages may be present between decode logic 515 and recirculation logic 520. And in one embodiment, recirculation logic 520 is coupled closely to execution logic 530, such as in a stage immediately preceding execution logic 530. Here, the size of a recirculation buffer (i.e. the size of code portion that is able to be accommodated) may be chosen based on a number of factors including: how large of a code section to accommodate, an amount of time to power-down and up front-end logic that dictates a minimum size of a code section to enable such power savings, a size of code section to ensure a performance benefit, cost and complexity of the storage structure, die space, and another known design tradeoff for implementing processor unit(s)/hardware.

In one embodiment, recirculation logic 520 also includes or is associated with control logic to perform code recirculation. In a most basic form the recirculation logic includes a dispatch-like logic (or re-use of existing processor dispatch logic) to dispatch the decoded instructions from the storage structure in recirculation logic 520. For example, much like an instruction pointer is utilized for referencing a current (or next based on the perspective) instruction to be executed, recirculation logic 520—in one example—includes a recirculation instruction pointer. In this scenario, instead of an instruction ‘address’, the recirculation instruction pointer points/references a current decoded instruction within the storage structure. As a simple illustrative example, the first instruction position in the storage structure is 0, and the positions count up. Here, the instruction pointer may simply include a register to hold a value (e.g. 3 referencing the 4th instruction position in the storage structure). The dispatch logic then dispatches the instruction referenced by the recirculation instruction pointer to execution logic 530 for execution and increments the instruction pointer to the next position in the recirculation storage structure. Moreover, when code section 505 includes a loop, then control logic is further to loop the recirculation instruction pointer when it reaches the ‘end’ of the loop (e.g. the end of the loop body, which may include a branch instruction to return execution to the start of the loop for another iteration) until an iteration condition is met (e.g. until the number of iterations through the loop have occurred or other end of iteration condition is encountered).

As alluded to above, in one embodiment, front-end logic 510 is powered-down during recirculation. In other words, after marked end instruction 507 is decoded, recirculation logic 520 is filled with the decoded format of hot code section 507. As a result, when recirculation from logic 520 is performed (i.e. decoded instructions are dispatched directly from the recirculation logic 520), front-end logic 510 no longer is fetching and providing instructions for code section 505. As a result, in this scenario, front-end logic 510 is powered-down to conserve energy during the ‘recirculation mode. As discussed in more detail below, branch prediction logic, in one embodiment, is to predict hot code section 505 as a branch not taken. Consequently, branch prediction logic causes a ‘next instruction’ after hot code section 505 to be fetched. And when front-end logic 510 is powered-down into a standby mode (and not an off mode), then the ‘next instruction’ is still resident in front-end 510. So after recirculation finishes and front-end 510 is powered up, the ‘next instruction’ is already fetched and ready to be propagated through the processor pipeline. Note that the front-end may be completely powered down in some embodiments; however, in these scenarios an extra time penalty may be incurred to save the additional power between the ‘standby’ mode (enough voltage to keep the data/information resident in front-end logic 510) and an off mode (VDD=0).

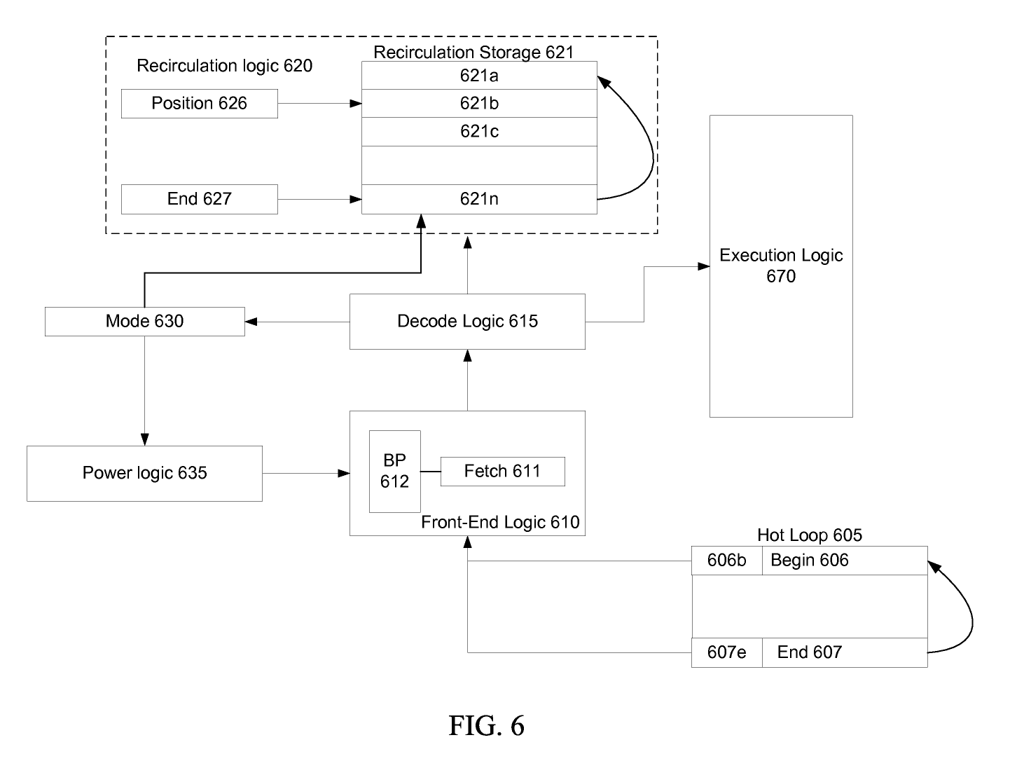

Turning to FIG. 6, another embodiment of a logical representation of modules to enable recirculation of hot sections of code is illustrated. Here, hot loop 605 in program code is identified. Although a hot loop is discussed below in reference to FIG. 6, it's important to note that similar modules, methods, and techniques may be applied to other hot code sections, which are mentioned above in reference to FIG. 5. In one embodiment, a dynamic optimizer/compiler determines that loop 605 iterates at least a threshold number of times; the threshold being included within any range or subset of ranges between 1 to 1000). During program analysis and simulation, it was determined that some programs spent between 30% to 90% of their overall execution time executing loops that iterated more than 5 times. Therefore, in this illustrative scenario assume that the threshold for loop iteration to determine a hot loop is 5. As a result, during runtime, the dynamic compiler environment tracks execution of hot loop 605. And hot loop 605 iterates 10 times, so the dynamic compiler environment determines loop 605 is hot.

Note that if hot loop 605 subsequently iterates less than 5 times, the identification may later be altered by the dynamic compiler. Moreover, the dynamic compiler, in another implementation, only identifies hot loop 605 after it has iterated more than the threshold 5 times over a plurality of separate instances of executing loop 605. Furthermore, identification is not limited to a dynamic compiler. Instead, identification may be done during static compilation, by microcode, by firmware, or by hardware itself.

However, continuing the example above utilizing a dynamic compiler, upon determining loop 605 is ‘hot,’ loop 605 is marked as hot by the software. In one embodiment, a single bit (bit 606b) is added to the encoding of begin loop instruction 606 for loop 605, so when bit 606b is set to a marked value it indicates that instruction 606 delimits a beginning of a hot loop. Here, bit 607e operates in a similar manner for end loop instruction 607. In one embodiment, such a bit is added to any instruction encoding to enable flexible marking for code sections. In another embodiment, such encoding is added only to specific instructions. For example, loop end bit 607e is added to branch instructions, since loops often end with a branch instruction that jumps back to the beginning of the loop or to another branch, while loop begin bit 607b is added to an atomic instruction that starts execution for a group of instructions or other instruction that starts execution of loop 605.

As a result, loop 605 may (through initial static compiler hint or other software identification) or may not (by default not hot) be determined to be hot. However, after execution in the example above, the dynamic compiler marks instructions 606 and 607 with bits 606b and 607e, respectively. During a subsequent execution, fetch logic 611 fetches hot loop 605 (e.g. at least begin instruction 606 for loop 605 and subsequent instructions to form an iterative hot section of code). Front-end logic 610, as illustrated, also includes branch prediction logic 612, which is described in more detail below. However, front-end logic 610 may also include other units, such as an instruction cache and/or instruction translation lookaside buffer (I-TLB).

Decode logic 615 recognizes the marked hot loop 605. Here, decode logic 615 decodes begin instruction 606 with bit 606b set to a marked or begin value. As a result, decode logic 615 signals recirculation logic 620 to enter a loop detection mode (i.e. logic 620 is to detect and load the instructions following the loop begin instruction 606 with the marked bit 606b). In one embodiment, mode register 630 is to hold a recirculation mode. Here, signaling recirculation logic 620 of a loop detection mode includes setting a recirculation mode field in register 630 to indicate recirculation logic 620 should enter a loop detection mode. In detection mode, as fetch logic 611 fetches instructions subsequent to begin instruction 606 in loop 605 and decode logic 615 decodes them; they are dispatched to execution logic 670. And at the same time they are queued, buffered, and/or loaded into recirculation storage 621. In other words, recirculation logic 620 is discovering or detecting the extent of loop 605 by storing each decoded instruction in a queue, buffer, or other storage structure 621.

The loop detection process continues until decode logic 615 decodes end instruction 607 with end bit 607e marked with an end hot section value or storage 621 overflows (i.e. loop 605 is too large for recirculation storage 621 and an exception is triggered). Upon detecting end instruction 607, mode register 630 is updated to reflect recirculation logic is to enter a loop recirculation mode (i.e. the loop is detected, the decoded format of loop 605 is held in storage 621, and the loop may be iterated through from recirculation storage 621, instead of having to re-fetch or obtain the loop instructions from an instruction cache in font-end 610). Also, a loop end register 627 is set to hold a reference an end hot section of code instruction 607 held in the recirculation buffer 621 (e.g. shown as being held in the last position 624n of buffer 621). However, depending on the size of loop 605 and buffer 621, the end register 627 may often reference a different position of storage 621 that holds end instruction 607 in a decoded format.

In one embodiment, recirculation logic 620 includes position register 626 to point to a current instruction to be dispatched. As illustrated, the current instruction includes a decoded instruction held in entry 624b. As a result, instruction 624b is dispatched to execution logic 670 for execution. And position register 626 is incremented to reference the next decoded instruction in entry 621c. When position register 626 references the same entry as end register 621 (i.e. indicating that the end of the loop has been reached), then position register 626 is reset to reference the decoded, first instruction held in entry 621a (i.e. the position register 626 is looped from the end back to the beginning)

Recirculation logic 620 continues to iterate through storage 621, looping and dispatching instructions to be executed by execution logic 670 until an end iterative end condition is met. The most typical end iteration condition is when the loop has iterated through the requisite number of times (e.g. a for loop is set to loop through 100 times, then an end condition is when the completes its 100th iteration). Often this is indicated by the end instruction 607's branch not being taken (i.e. the branch to return back to the start of the loop is not taken because the number of iterations condition has been met for the loop). Examples of other iterative end conditions include taking a branch from within the loop body that doesn't return to the beginning of the loop, an exception, an interrupt, or any other known break in processor execution.

In one embodiment, during the loop recirculation mode, power logic 635 is to power down front-end logic 610. Here, branch prediction logic 612, fetch logic 611, and any instruction cache may be powered down to save energy, while the processor executes from recirculation logic 620. In one embodiment, power logic 635 is to place front-end 610 into a power-off mode (i.e. clock and power gated). Yet here, current information in front-end 610 would be lost. So in another embodiment, front-end 610 is powered down into a standby mode, where clocks are gated and power is reduced, such that information in front-end 610 is maintained. Since front-end 610 is in standby mode, instructions fetched after loop 605 stay in front-end 610's pipeline latches during the loop recirculation mode. And when the end iterative condition is met and the loop recirculation mode is exited (as represented here in register 630), the next instructions (after loop 605) continue to move along through front end 610's pipeline. In other words, front-end 610 is frozen upon entering loop recirculation mode and unfrozen when exited. And this behavior results in a potential performance benefit (i.e. the latency for fetching the next instructions is avoided).

Moreover, with branch prediction 612 being in standby as well, it doesn't train/learn during execution of loop 605. Previously, during execution of hot loop 605, branch predictor would train that the end instruction 607 branch to the start of the loop is mostly-taken. But since branch predictor 612 is not trained during that time, it doesn't train the last branch as mostly taken. Furthermore, upon starting to train again after exiting the loop recirculation more, branch prediction 612 isn't aware of the time lapse for recirculation of loop 605 and determines the branch to begin instruction 606 is mostly-not-taken. In some instances, this mis-training would be bad. However in this scenario, when the branch is predicted as mostly not taken, upon subsequent prediction and fetch, branch prediction logic 612 causes fetch logic to fetch the instructions after loop 605. And as a result, the performance benefit described above (having instruction after the loop ready and frozen in the front-end during loop recirculation) is achieved.

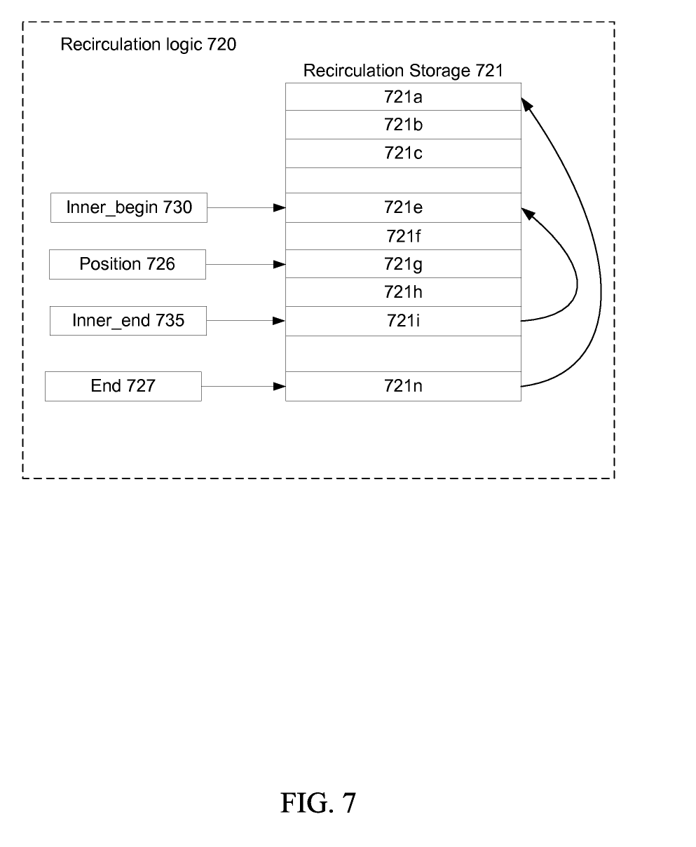

Referring next to FIG. 7, an embodiment of recirculation logic capable of handling nested loops is depicted. Similar to the discussion of FIG. 6, recirculation logic 720 includes storage structure 721 to hold a decoded format of hot loop instructions, position register 726 to act as a recirculation instruction pointer, and an end register 727 to point to a decoded end instruction for the hot loop. Moreover, when software identifies a hot loop and marks an outer loop has a hot loop, nested loops therein may also be marked marked with inner loop begin and end bits (i.e. marked as hot). As a result, a hot loop with a nested loop includes code marked with a begin hot loop instruction, a begin inner loop instruction, an end inner loop instruction, and a hot loop end instruction.

When a begin inner loop instruction is decoded, inner loop begin register 730 is set to point to a decoded inner loop begin instruction in entry 721e. And since the instruction represents a start of an inner loop within a hot loop, recirculation logic 720 is already in a loop recirculation mode. As a result, the execution continues until the end inner loop instruction is encountered. The inner loop is recirculated (i.e. when position register 726 reaches entry 721i referenced by inner loop end register 735, position register 726 loops back to entry 721e referenced by inner loop begin register 730) until an end inner loop condition is met. Here, when the inner loop exits (i.e. is to not take the branch at the end instruction 721i to return to the beginning of the inner loop at entry 721e, which is referenced by inner loop end register 735), recirculation logic 720 is to stay in the loop recirculation mode for the outer loop. So the recirculation mode is not exited but rather continued. Note that during the initial dynamic code profiling, the inner loop may first be determined as a hot loop before the outer loop, because the inner loop potentially iterates many times for each pass through the outer loop (e.g. 100 iterations through an inner loop upon each pass of an outer loop that loops 10 times). However, if the outer loop then iterates many times (e.g. the 10 times in comparison to a 5 loop threshold), it is also marked as a hot loop for recirculation.

In other words, the inner loop operates in a similar manner to previous hot loop detection and recirculation. However, loops generally continue rather than finish, so an assumption that all branches after the inner loop will not be taken is potentially not correct. For example, if hardware predicts that the inner loop branch will be taken and jumps to the inner loop header, then the inner loop will be buffered in recirculation queue 721 as unrolled, which will result in an overflow of queue 721. Therefore, in one embodiment, to prevent this overflow scenario, front-ends and back-ends handle an inner loop branch differently. Here, when decode logic decodes the inner loop end bit from the inner loop end instruction, the front-end assumes the inner loop branch is not taken and buffers the next instructions until it decodes the loop end bit in the loop end instruction for the outer loop. However, the back-end takes the inner loop branch and iterates through the inner loop in a recirculation mode, reusing instruction from recirculation queue 721. As a result, the front-end is in a detection mode until the outer loop end instruction is decoded, while the back end is in a loop recirculation mode from the time that the end inner loop instruction is decoded to the time when the outer loop end instruction is decoded from branch prediction, causing the next instructions after the inner loop end instruction to be fetched. Note that the compiler may also insert a number of operations before the inner loop branch if it is located with a number of cycles (e.g. 3-4) of the inner loop header (begin instruction).

Moreover, when the inner loop finishes, the branch is not taken and may cause a branch misprediction in the loop recirculation mode. Previously, the recirculation mode would be exited in response to a branch misprediction. However, a branch misprediction, in one embodiment, does not cause an exit from a loop recirculation mode for an inner loop branch. Instead, in this scenario, execution stages of a processor pipeline are flushed, while the instructions are re-issued from the recirculation queue. When recirculation logic 720 receives a misprediction signal from execution stages, it checks if the misprediction is caused by an inner loop branch. If so, then the recirculation queue 721 issue the next instruction after the branch, staying in the loop recirculation mode. However, if it's not caused by the inner loop branch, then the loop recirculation mode is exited.

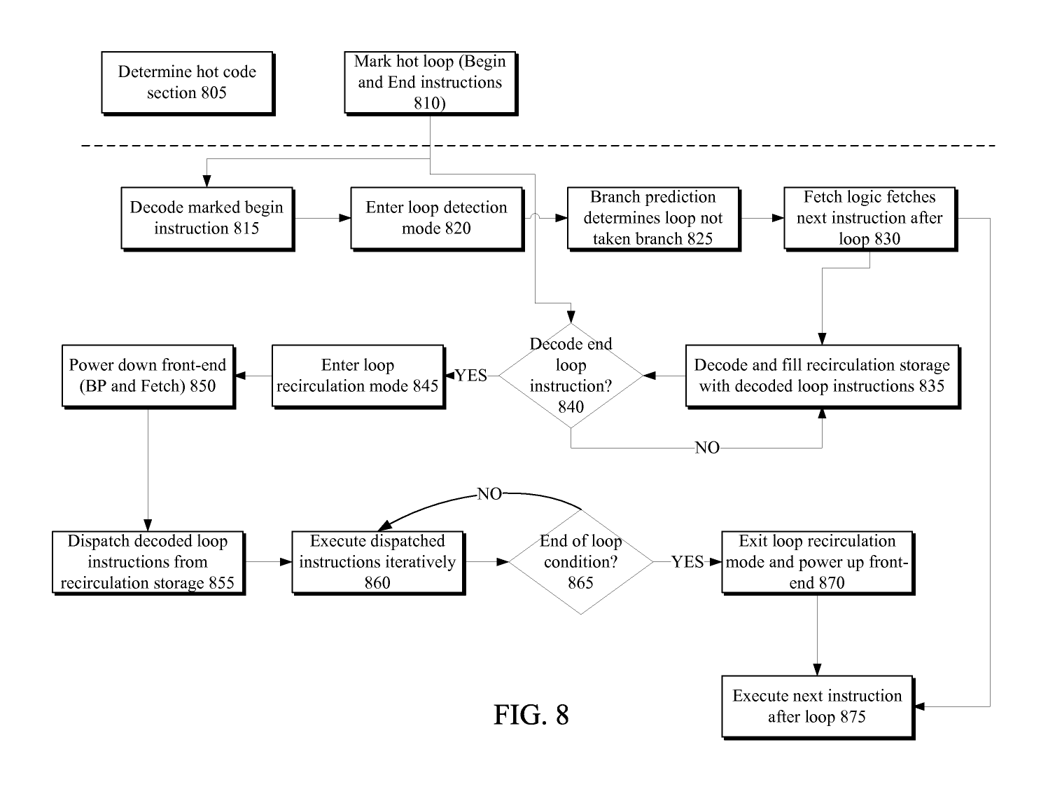

Moving to FIG. 8, an embodiment of modules and/or a representation of a flow diagram for a method of recirculating loop code and saving power is shown. Note that the flows (or modules) are illustrated in a substantially serial fashion. However, both the serial nature of these flows, as well as the depicted order, is not required. For example, in reference to FIG. 8, powering down and powering up a front-end may not be specifically performed in some implementations. Instead, power may be maintained, while performance is increased through the proximity of recirculation. Also, the flows are illustrated in a substantially linear or serial fashion. However, the flows may be performed in parallel or in a different order. In addition, any of the illustrated flows or logical blocks may be performed within hardware, software, firmware, or a combination thereof. As stated above and below, each flow, in one embodiment, represents a module, portion of a module, or overlap of modules. Moreover, any program code in the form of one or more instructions or operations, when executed, may cause a machine to perform the flows illustrated and described below.

In flow 805, a hot code section is determined. As stated above, hardware, firmware, software, or a combination thereof determines if a section code is hot. For example, if a portion of code is executed more than a number of times over a period of time, then it's determined to be ‘hot.” As another example, where the section of code is a loop, the loop is determined to be a hot loop if it iterates more than a predetermined number of times. As a result, if a loop is determined to be a hot loop in flow 805, then the hot loop is marked in flow 810 (e.g. bits in a begin loop instruction and end loop instruction are set by a dynamic compiler to demarcate the loop as a hot loop).

In flow 815, the begin mark instruction is decoded. And in response to decoding the marked begin loop instruction, the recirculation logic enter a loop detection mode in flow 820. Moreover, branch prediction logic determines the loop branch is not taken in flow 825. Since the loop branch is predicted as not taken, then the branch predictor causes fetch logic to fetch one or more next instructions after loop 830. As the loop is decoded, recirculation storage is filled with a decoded format of the loop instructions in flow 835. At the same time as the filling of recirculation storage, the instructions that were decoded are dispatched (either from the recirculation storage or normal buffer storage) and executed for a first iteration of the loop.

When the end loop instruction is decoded in flow 840, then recirculation logic enters loop recirculation mode in flow 845. Upon entering the loop recirculation mode in flow 845, a front end or portion thereof (e.g. branch predictor, fetch logic, and instruction cache) are powered down into a standby mode (e.g. a reduced voltage and/or clock gated) in flow 850. During the loop recirculation mode, the decoded loop instructions are dispatched to execution logic from recirculation storage in flow 855. Execution logic executes the instructions iteratively as they are dispatched in flow 860 until an end loop condition is encountered in flow 865. Once the end loop condition is encountered, then the loop recirculation mode is exited and the front-end is powered on into an active or operating state in flow 870. And since the front-end previously fetched the next instruction after the loop, then the next instruction is propagated through the processor pipeline and executed in flow 875.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus for efficient energy consumption comprising:
front-end logic configured to fetch at least an iterative hot section of code;
decode logic coupled to the front-end logic, the decode logic configured to recognize the iterative hot section of code;
recirculation logic coupled to the decode logic, the recirculation logic configured to hold a decoded format of instructions from the iterative hot section of code;
execution logic coupled to the recirculation logic, the execution logic configured to iteratively execute the decoded format of instructions held in the recirculation logic until an iterative end condition is detected; and
power logic configured to power down the front-end logic to a standby mode during the execution logic iteratively executing the decoded format of instructions until the iterative end condition is detected.

2. The apparatus of claim 1, wherein the decode logic coupled to the front-end logic configured to recognize the iterative hot section of code comprises:
the decode logic being configured to recognize a begin hot section of code instruction at a beginning of the iterative hot section of code and an end hot section of code instruction at the end of the iterative hot section of code, wherein the begin hot section of code instruction is to include a begin hot section field set to a begin value and the end hot section of code instruction is to include an end hot section field set to an end value.

3. The apparatus of claim 1, wherein the recirculation logic configured to hold a decoded format of instructions from the iterative hot section of code comprises: a recirculation buffer configured to hold the decoded format of instructions for the iterative hot section of code in program order, and wherein the recirculation logic further comprises a loop position register configured to hold a reference to current execution position within the recirculation buffer and a loop end register configure to hold a reference to a decoded format of the end hot section of code instruction held in the recirculation buffer.

4. The apparatus of claim 3, wherein the recirculation logic is further configured to dispatch a decoded format of an instruction from the current execution position referenced in the loop position register for execution by the execution logic and to increment the loop position register to hold a reference to a next execution position within the recirculation buffer.

5. The apparatus of claim 2, wherein the front-end logic comprises branch prediction logic adapted to predict branches to be taken, fetch logic to fetch the at least the iterative hot section of code, and an instruction cache.

6. The apparatus of claim 5, wherein the power logic configured to power down the front-end logic to a standby mode during the execution logic iteratively executing the decoded format of instructions until the iterative end condition is detected comprises:
a mode register, the mode register being configured to hold a recirculation mode indicator, wherein the recirculation mode indicator is to be set to a loop detection mode indicator in response to the decode logic recognizing the begin hot section of code instruction and is to be set to a loop recirculation mode indicator in response to the decode logic recognizing the end hot section of code instruction;
control logic configured to power down the branch prediction logic, the fetch logic, and the instruction cache into the standby mode in response to the recirculation mode indicator to be held in the mode register being set to the loop recirculation mode indicator.

7. The apparatus of claim 1, wherein the iterative end condition being detected is selected from a group consisting of a last branch not taken being detected, an end to iteration through a loop being detected, another branch taken being detected, an exception being detected, and an interrupt being detected.

8. An apparatus for efficient energy consumption comprising:
decode logic configured to decode a begin instruction to indicate a beginning of a hot section of code and an end instruction to indicate an end of the hot section of code;
recirculation logic coupled after the decode logic in a processor pipeline, the recirculation logic configured to hold a decoded format of instructions from the hot section of code in response to the decode logic decoding at least the begin instruction and to dispatch the decoded format of instructions for execution; and
execution logic coupled after the recirculation logic in the processor pipeline, the execution logic configured to execute the decoded format of instructions in response to the decoded format of instruction being dispatched from the recirculation logic.

9. The apparatus of claim 8, wherein the hot section of code includes a hot loop, the begin instruction includes a begin loop instruction with a begin marked bit to indicate the begin loop instruction is to begin the hot loop, and the end instruction includes an end loop instruction with an end marked bit to indicate the end loop instruction is to end the hot loop.

10. The apparatus of claim 9, wherein recirculation logic configured to hold a decoded format of instructions from the hot section of code in response to the decode logic decoding at least the begin instruction and to dispatch the decoded format of instructions for execution comprises:
a recirculation storage structure configured to hold the decoded format of instructions from the hot loop;
a recirculation instruction pointer configured to point to a current decoded format instruction of the decoded format of instructions;
dispatch logic configured to dispatch the current decoded format instruction to the execution logic in response to the recirculation instruction pointer pointing to the current decoded format instruction; and
loop logic to loop the recirculation instruction pointer from the end of the hot loop to the beginning of the hot loop until an iteration end condition is met.

11. The apparatus of claim 9, further comprising front-end logic configured to fetch the hot section of code; and power logic configured to power down the front-end logic during the execution logic executing the decoded format of instructions in response to the decoded format of instruction being dispatched from the recirculation logic.

12. A method for efficient energy consumption comprising:
determining a hot section of code;
marking a begin instruction for the hot section of code and an end instruction for the hot section of code;
decoding the begin instruction for the hot section of code, the end instruction for the hot section of code, and a plurality of instruction within the hot section of code to obtain a decoded format of the hot section of code;
loading a recirculation storage structure with the decoded format of the hot section of code; and
iteratively executing the decoded format of the hot section of code from the recirculation storage structure until an end recirculation condition is met.

13. The method of claim 12, wherein determining a hot section of code comprises dynamically determining a runtime compiler environment the hot section of code is iteratively executed at least a predetermined number of times.

14. The method of claim 12, wherein the hot section of code comprises a hot loop, and wherein marking a begin instruction for the hot section of code and an end instruction for the hot section of code comprises marking a begin loop instruction for the hot loop and an end loop instruction for the hot loop.

15. The method of claim 12, further comprising dispatching the decoded format of hot section of code during loading the recirculation storage structure with the decoded format of the hot section of code.

16. The method of claim 12, wherein the recirculation storage structure includes a recirculation queue coupled after the decode logic and before execution logic.

17. The method of claim 12, wherein the end recirculation condition is selected from a group consisting of a last branch not taken being detected, an end to iteration through a loop being detected, another branch taken being detected, an exception being detected, and an interrupt being detected.
